(19) United States
(12) Patent Application Publication
(10) Pub. No.: US 2006/0118761 A1
(43) Pub. Date: Jun. 8, 2006

(54) Corrosion inhibition method for use in recirculating cooling water systems

(76) Inventor: William E. Stapp, Santa Rosa, CA (US)

Correspondence Address: PERKINS COIE LLP, P.O. BOX 2168, MENLO PARK, CA, 94026, US

(21) Appl. No.: 11/262,037

(22) Filed: Oct. 27, 2005

Related U.S. Application Data
(60) Provisional application No. 60/622,750, filed on Oct. 27, 2004.

(51) Int. Cl. C02F 5/08

(52) U.S. Cl. 252/175

(57) ABSTRACT

Methods are described for inhibiting corrosion of corrodible metals present in contact with water in recirculating cooling water systems. The compositions employed are particularly effective at high temperatures and/or high hardness levels, and form little or no deposits on the metal surface.

This application claims priority to U.S. Provisional Patent Application No. 60/622,750 filed Oct. 27, 2004, which is incorporated herein in its entirety by reference.

### FIELD OF THE INVENTION

The present invention relates to methods for inhibiting corrosion of corrodible metals present in contact with water in recirculating cooling water systems, and in particular to methods effective at high temperatures and/or high hardness levels.

### BACKGROUND OF THE INVENTION

Metal surfaces in cooling water systems are subject to high levels of corrosion due to various factors, including the high temperatures to which the metals are exposed. Heat exchanger surface (skin) temperatures can reach about 200° F., which accelerates the chemical reactions resulting in corrosion. In addition, the water used in such systems is often of moderately high alkalinity (about pH 8-9) and high hardness, having very high levels (e.g. about 200 ppm or more) of dissolved metal cations such as calcium and magnesium.

Conventionally, cooling water in such systems is treated with phosphate-based corrosion inhibitors, which react with dissolved calcium to form calcium phosphate, which forms a barrier deposit on the metal surface. Care must be taken, however, not to overfeed the phosphate, as too thick a layer of calcium phosphate impairs heat transfer. Typically, heat transfer degrades over time, and the affected equipment must be disassembled and cleaned periodically.

Accordingly, a corrosion inhibitor which is effective to inhibit corrosion under these conditions, but which does not form a deposit on the metal surface, would be desirable.

### SUMMARY OF THE INVENTION

In one aspect, the invention embodies a method for inhibiting corrosion of corrodible metal in contact with water in a recirculating cooling water system, where the cooling water attains temperatures of 80° F. through 160° F. or higher during standard operating conditions. Typically, the pH of the cooling water in such systems is 8 or higher, and the calcium ion concentration is 150 ppm, 200 ppm or higher. The corrodible metal is typically a ferrous metal, copper or brass. In one embodiment of the method, the corrodible metal is a ferrous metal, such as carbon steel.

The method comprises: (a) adding to the water system, a composition comprising a stannous salt of a non-carbon acid, or an aqueous solution thereof, and (b) maintaining in the water system a concentration of said stannous salt which corresponds to a concentration of tin (Sn⁺²) between about 0.5 and about 10 ppm, preferably between about 1 and about 5 ppm.

In one embodiment, the stannous salt is preferably selected from the group consisting of stannous bromide, chloride, sulfate, nitrate, and oxide, and is more preferably stannous chloride. Preferably, the stannous salt is added in the form of an aqueous solution.

These and other objects and features of the invention are made more fully apparent in the following detailed description of the invention.

### BRIEF DESCRIPTION OF THE FIGURES

FIG. 1 is a graph of the MS probe readings in the PO₄ treated system.

FIG. 2 is a graph of the MS probe readings in the AS-8111 treated system.

FIG. 3 shows FIGS. 1 and 2 on a single graph.

FIG. 4 shows a PO₄-treated coupon close-up and turned over, after the final cleaning with inhibited 6 N hydrochloric acid.

FIG. 5 shows an AS-8111-treated coupon close-up and turned over, after the final cleaning with inhibited 6 N hydrochloric acid.

Data from the two test systems are shown in Tables I and II.

Table III shows a water analysis of the test waters conducted after the completion of the tests.

### DETAILED DESCRIPTION OF THE INVENTION

I. Definitions

“Corrosion” of a metal in contact with water, as used herein, refers to degradation of the metal due to chemical reaction with its environment, in this case, water and substances present in the water, including air. Such corrosion ultimately leads to dissolution or dispersion of the metal or metal compound in the water, observed as a loss of mass of the metal.

A “non-carbon” acid is an acid containing no carbon atoms, e.g. hydrochloric, sulfuric, phosphoric, or nitric acid.

As used herein, an “aqueous solution” of a stannous salt of a non-carbon acid refers to a composition of the salt in water, preferably in fairly high concentration, i.e., about 30 weight percent or greater, if the salt is of sufficient solubility in water to achieve this concentration. The composition may include an acid, e.g. HCl, H₂SO₄, or HNO₃, to promote dissolution of the stannous salt. There are no other components in any appreciable concentration.

A “composition consisting essentially of” a stannous salt of a non-carbon acid (or aqueous solution) refers to the stannous salt, or aqueous solution, in combination with one or more optional components which do not materially affect the metal corrosion inhibiting characteristic(s) of the composition. Such components would typically be substances added to a distributive water stream for purposes other than inhibition of corrosion, as defined above. For example, dispersing or chelating agents, such as soluble anionic polymers (e.g. polyacrylates or acrylate copolymers), may be employed to reduce scale formation on solid surfaces; biocides may be added to reduce microbial growth.

A similar definition applies to compositions “consisting essentially of” a stannous salt of a non-carbon acid (or aqueous solution) and an alkali metal phosphate. Such compositions may also include components present for purposes other than inhibition of corrosion.

A “concentration of stannous salt which corresponds to a concentration of tin” in a given concentration range is determined from the relative molecular weights of the components. For example, 1.0 ppm tin corresponds to approx. 1.8 ppm SnSO₄, 1.6 ppm SnCl₂, or 2.3 ppm SnBr₂.

A “AS-8111” refers to Applicant's product, which is a composition consisting essentially of a stannous salt of a non-carbon acid, or an aqueous solution thereof, that is used for inhibiting corrosion of corrodible metal in contact with water in a cooling water system. The application of the composition involves maintaining in said water system a concentration of said stannous salt which corresponds to a concentration of tin (Sn⁺²) between about 0.5 and about 10 ppm, wherein said cooling water attains temperatures of at least 80° F., and up to 160° F., during standard operating conditions. A more typical lower limit is 120° F., and a more typical upper limit is 140° F.

II. Use of Aqueous Stannous Salt Solutions in Corrosion Inhibition

As noted above, metal surfaces in cooling water systems are subject to high levels of corrosion due to various factors, including the high temperatures to which the metals are exposed. Heat exchanger surface (skin) temperatures can reach about 200° F., which accelerates the chemical reactions resulting in corrosion. Bulk water temperature of cooling water in contact with such surfaces typically reaches about 140° F.

In accordance with the invention, a composition consisting essentially of a stannous salt of a non-carbon acid, or an aqueous solution thereof, is added to a water system used for cooling, where the water reaches temperatures of at least 80° F., more typically at least 140° F., during standard operation, and a concentration of the stannous salt which corresponds to a concentration of tin (Sn⁺²) between about 0.5-10 ppm, preferably about 1-5 ppm, more preferably 2-3 ppm, is maintained in the water system. A more typical lower limit for the water temperature is 120° F., and a more typical upper limit is 140° F. The concentration of Sn⁺² in the water system may be monitored by techniques known in the art and adjusted as necessary to maintain the desired concentration. The method is particularly beneficial for such a water system having a high hardness, represented by a calcium ion concentration of at least 150 ppm, or at least 200 ppm.

To form the corrosion inhibiting compositions, any stannous salt of a non-carbon acid having sufficient aqueous solubility to be maintained in a cooling water system at a concentration corresponding to a selected tin level in the range of about 0.5 to 10 ppm, preferably 1 to 5 ppm, may be used. Preferred salts include stannous bromide, chloride, sulfate, nitrate, oxide, pyrophosphate, perchlorate, tetrafluoroborate, monofluorophosphate, ammonium fluoride, sodium fluoride, and fluorosilicate, and particularly preferred salts include stannous bromide, chloride, sulfate, nitrate, and oxide. In one embodiment, the salt is stannous chloride.

Stable aqueous solutions of these compounds are often more readily prepared by adding water to the salt, rather than the reverse order of addition. For example, highly concentrated aqueous stannous chloride solutions, i.e. about 50 weight percent up to about 90 weight percent SnCl₂, can be conveniently prepared by adding water to stannous chloride in the desired weight ratio and stirring for a brief period of time. Dissolution is enhanced by using slightly acidified (e.g. dilute HCl) water.

The stannous salt compositions are effective, at relatively low concentrations, to inhibit corrosion of metals under conditions of high temperature, as noted above, and do not form a deposit on the metal surface, as do conventional phosphate based inhibitors. The compositions are effective to inhibit corrosion of ferrous metals, such as carbon steel, as well as other metals such as copper, lead, and brass. The stannous salt compositions may also operate to remove existing corrosion product from steel surfaces, as stannous ion reduces ferric ion (Fe⁺³) to ferrous ion (Fe⁺²). In addition, the aqueous stannous salt compositions do not contain any organic solvents or other organic components, and thus do not promote growth of microorganisms.

III. Results of Comparison of AS-8111 with the orthophosphate ion Applicants conducted several experiments to compare the corrosion inhibiting properties of AS-8111 with the ortho-phosphate ion (PO₄)⁻³ under similar operating conditions. No other water treatment chemical was included in the test. The test involved assembling two identical recirculating test systems that included an Advantage Model ADPM-1-A Scale Monitor.

Results indicate that AS-8111 compared favorably with ortho-phosphate as a corrosion inhibitor for carbon steel. Linear polarization readings on the phosphate system did not reach as low a plateau as did the AS-8111-treated system. Mild steel corrosion coupons in the AS-8111 system showed a higher corrosion rate based on metal loss; however, the phosphate-treated coupons showed aggressive attack by gouging and pitting whereas the AS-8111-treated coupons showed more of a general etch. A high initial corrosion rate on the AS-8111-treated coupon as shown on the LPP readings would account for the high weight loss.

Linear polarization (LP) readings for “mild” (carbon) steel (MS) on the PO₄-treated system started out at 13.64 MPY, jumped to 21.81 MPY for one reading, returned to 14, 15, 12, to a low of 10.21, with an average of 13.81 MPY for a total of 22 days.

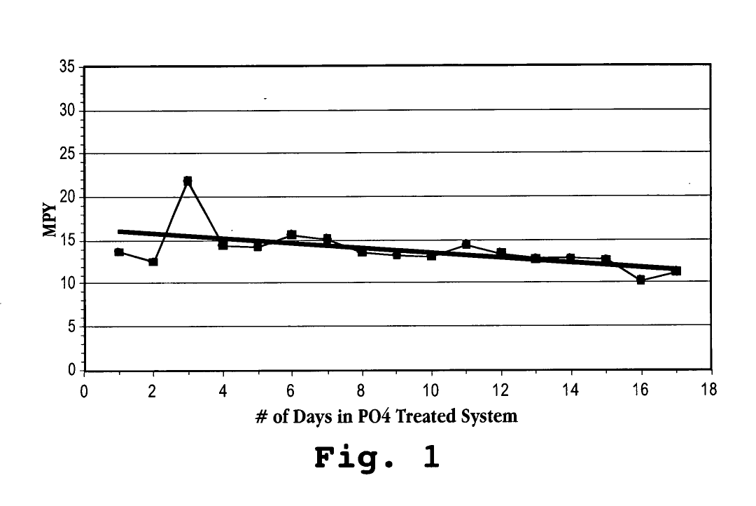

The MS LP readings for the AS-8111-treated system started high at 28.82 MPY, dropped to 23.5, 17.0, 15.4, 13.6, 11.0, 9.0, 7.0, 5.8,4.2, to a low of 3.7 MPY and an average of 13.50 MPY (see Tables I and II and FIGS. 1, 2 and 3) over the same 22 days under the approximately same conditions.

The PO₄-treated corrosion coupon showed a weight loss of 2.95% for a calculated corrosion rate of 13.2 MPY, very close to the average of the LP readings. The AS-8111-treated coupon showed a weight loss of 5.64% for a CR of 25.62 MPY, twice the LP average and the PO₄-treated coupon MPY.

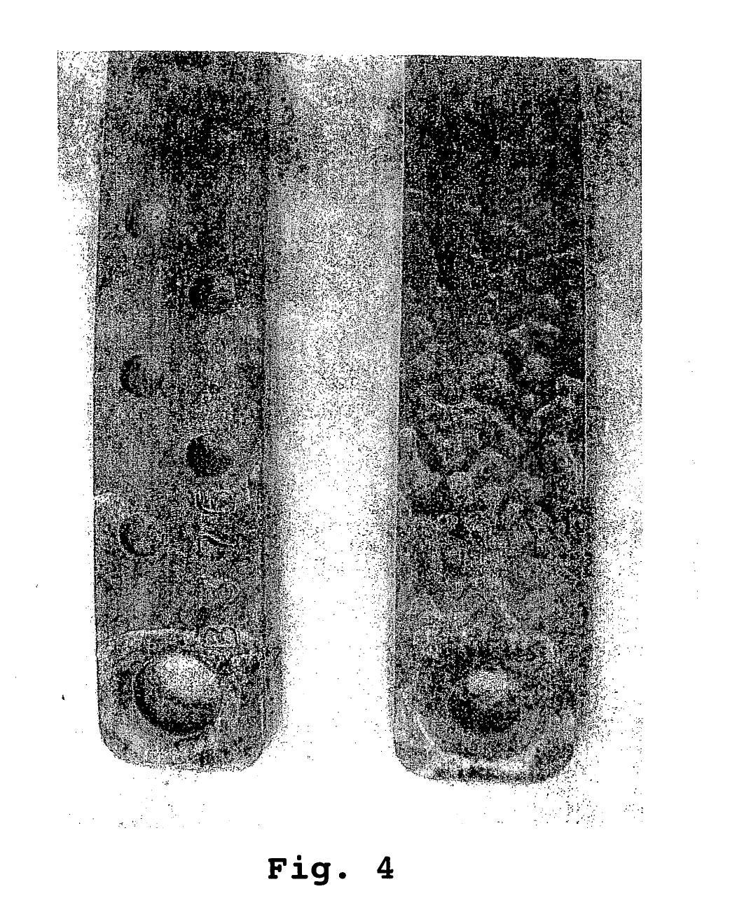

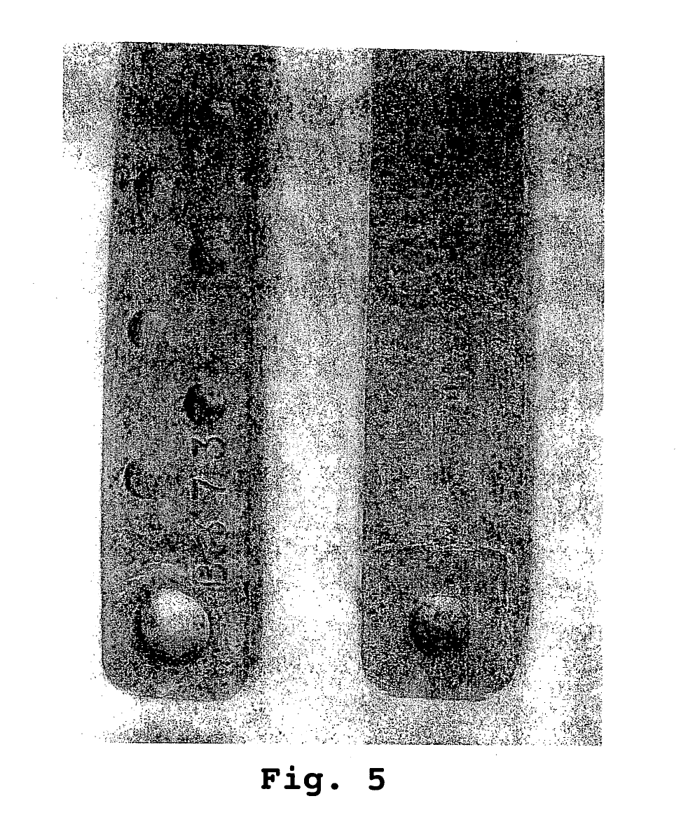

The AS-8111-treated coupon weight loss, however, included the initial high corrosion rate that generally becomes less and less significant the longer the coupon is in the system. The appearance of the cleaned PO₄-treated coupon showed gouging and pitting. The AS-8111-treated coupon showed a “general etch” type of corrosion that is much slower in causing penetration of the metal. (See FIGS. 4-5).

A. Iron Corrosion Tests

Once steady state conditions were achieved, the tests were run from Mar. 17, 2005 though Apr. 6, 2005. Mil per year (MPY) LPP readings, as well as temperatures, pH, time and date, were taken daily except for Sundays. Evaporation, approximately 1½ gallon per day was made up with DI water daily, including weekends.

After makeup and before each set of readings, a suitable time (ten turnovers of the system volume) was allowed for the makeup and the treatment present to become completely mixed. Samples run by the Myron L combination pH, conductivity and temperature instrument were returned to the system as they are not changed during the readings. Data from the two systems are shown in Tables I and II.

TABLE I
AS Inc./Copper Test Results on SnCl₂ Treatment

| | AS-8111 | | AS-8111 | | AS-8111 |
|---|---|---|---|---|---|
| | Cu Probe | | Adm. Probe | | Cu:Ni Probe |
| TestSeqnc. | Rdgs MPY | TestSeqnc. | Rdgs MPY | TestSeqnc. | Rdgs MPY |
| 1 | 0.24 | 1 | 0.58 | 1 | 2.01 |
| 2 | 0.15 | 2 | 1.17 | 2 | 1.50 |
| 3 | 0.21 | 3 | 1.47 | 3 | 1.28 |
| 4 | 0.20 | 4 | 1.08 | 4 | 1.08 |
| 5 | 0.10 | 5 | 0.97 | 5 | 0.53 |
| 6 | 0.21 | 6 | 1.33 | 6 | 1.65 |
| 7 | 0.17 | 7 | 0.75 | 7 | 0.99 |
| 8 | 0.13 | 8 | 0.64 | 8 | 0.37 |
| 9 | 0.10 | 9 | 0.84 | 9 | 0.42 |
| 10 | 0.14 | 10 | 1.25 | 10 | 0.31 |
| 11 | 0.10 | 11 | 0.92 | 11 | 0.18 |
| 12 | 0.12 | 12 | 0.80 | 12 | 0.26 |
| 13 | 0.12 | 13 | 0.98 | 13 | 0.23 |
| 14 | 0.12 | 14 | 0.64 | 14 | 0.13 |
| 15 | 0.19 | 15 | 0.64 | 15 | 0.14 |
| 16 | 0.26 | 16 | 1.37 | 16 | 0.40 |
| Avg. | 0.16 | Avg. | 0.96 | Avg. | 0.72 |

TABLE II
ASInc./MS Test Results on PO₄ Treatment

| | | | | | PO₄ |
|---|---|---|---|---|---|
| | Temp. | | | | MS Probe |
| TestSeqnc. | * F. | TestSeqnc. | pH | TestSeqnc. | Rdgs. MPY |
| 1 | 136 | 1 | | 1 | 13.64 |
| 2 | 140 | 2 | 8.34 | 2 | 12.52 |
| 3 | 138 | 3 | 8.50 | 3 | 21.81 |
| 4 | 144 | 4 | 7.06 | 4 | 14.44 |
| 5 | 144 | 5 | 7.17 | 5 | 14.30 |
| 6 | 140 | 6 | 7.06 | 6 | 15.64 |
| 7 | 144 | 7 | 8.00 | 7 | 15.11 |
| 8 | 140 | 8 | 8.18 | 8 | 13.53 |
| 9 | 140 | 9 | 8.17 | 9 | 13.25 |
| 10 | 140 | 10 | 8.45 | 10 | 13.02 |
| 11 | 146 | 11 | 8.33 | 11 | 14.42 |
| 12 | 145 | 12 | 8.47 | 12 | 13.39 |
| 13 | 140 | 13 | 8.42 | 13 | 12.78 |
| 14 | 144 | 14 | 8.40 | 14 | 12.82 |
| 15 | 142 | 15 | 8.52 | 15 | 12.64 |
| 16 | 148 | 16 | 8.27 | 16 | 10.21 |
| 17 | 142 | 17 | 8.58 | 17 | 11.22 |
| Avg. | 141.9 | Avg. | 8.12 | Avg. | 13.81 |

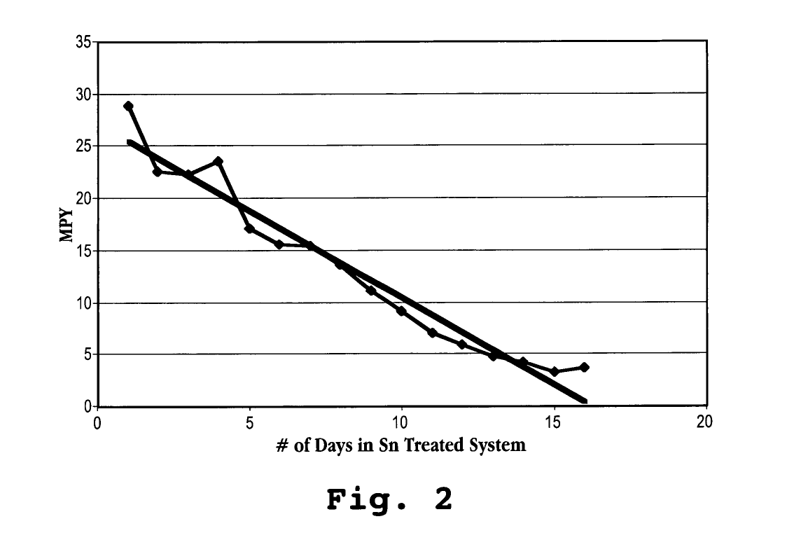

The Average pH and temperatures for the two systems were reasonably close, as were the average corrosion rates. FIG. 1 is a graph of the MS probe readings in the PO₄-treated system. FIG. 2 is a graph of the MS probe readings in the AS-8111 treated system. Note the slope (Y) of the trendlines. FIG. 1 and Table II show that the corrosion rate in the PO₄-treated system had leveled off for about the last five readings at 10 to 12 MPY. FIG. 2 and Table I show that the corrosion rate in the AS-8111 treated system had leveled off for about the last four readings at 3 to 5 MPY.

This may be explained by the fact that the PO₄⁻³ ion reacts almost immediately, forming a calcium phosphate or iron phosphate deposit on some of the areas on the probe; whereas the AS-8111 took longer to form its protective barrier. It is this particular feature of the invention, the lack of formation of a calcium phosphate or iron phosphate deposit, which contributes to the useful benefits of the system. The absence of such deposits is thought to extend the life of heat exchangers so they will not loose effectiveness over time at high temperatures.

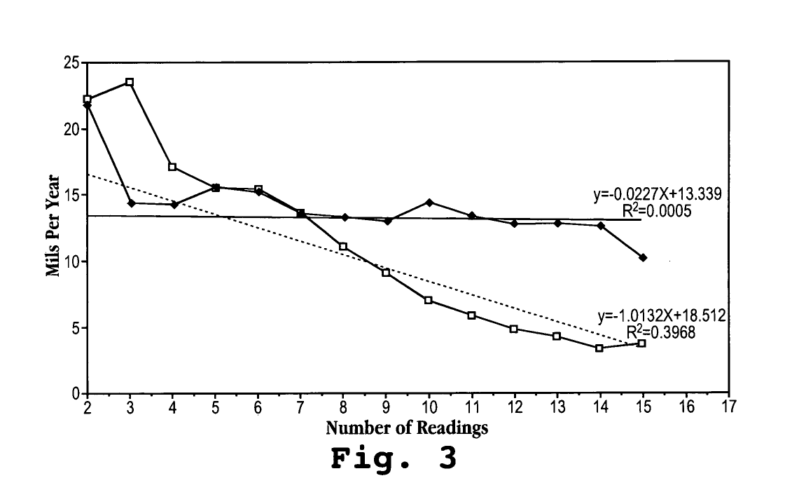

FIG. 3 shows FIGS. 1 and 2 on a single graph. It is unlikely that the curve or the trendline for the PO₄ corrosion rate would have reached the low rate achieved by the AS-8111.

The coupons and probes were removed from the systems at the end of the test. (See FIGS. 4-5). The cleaned MS corrosion coupons show a story similar to the graphs. FIG. 4 shows the PO₄-treated coupon close-up and turned over, after the final cleaning with inhibited 6 N hydrochloric acid. FIG. 5 shows the AS-8111-treated specimen. The deposits on the MS specimens from the AS-8111-treated system were darker than those in the PO₄-treated system. This may indicate reduction of the ferrous and/or ferric oxide(s) to the magnetite form.

The types of corrosion that occurred in the two systems appear to be quite different. The coupons from the PO₄-treated system show localized attack and are gouged. The coupons from the AS-8111-treated system show more of a general etch. Both sets show crevice corrosion under the coupon holder and bolt and nut.

The deposits on the MS specimens from the AS-8111 treated system effervesced vigorously when cleaned with 6 N Hydrochloric acid, indicating carbonate. The deposits on the MS specimens from the PO₄-treated system produced very little gas evolution.

The AS-8111-treated coupons had greater weight loss and hence higher MPY corrosion rates than the PO₄-treated coupons. The weight loss includes the metal taken off by the initial corrosion. It is customary to pretreat a new or cleaned system with dosages of the inhibitor several times its expected maintenance dose. This was not done; however, at 10 mg/L PO₄, the PO₄ test started out at a not-much-higher rate than it finally achieved, while the AS-8111 required several days to “catch-up” with the PO₄.

At the completion of the tests, the test waters were sampled and analyzed as seen in Columns D and E in Table III, along with the makeup and the original test waters. It is noted that the increase in the total amount of dissolved solids and the conductivity in the PO₄-treated test water was greater than that found in the AS-8111-treated test water.

TABLE III
WATER ANALYSIS

| | A | B | C | D | E |
|---|---|---|---|---|---|
| | SPECIFIC SAMPLE DESCRIPTION | | | | |
| | Evergreen | Prepared | Prepared | | |
| | Tap H₂O | AS-8111 | PO₄ | AS-8111 | PO₄ |
| CONSTITUENTS: | | Test Water | Test Water | Test Water | Test Water |
| | | | | end of test | end of test |
| TOTAL DISSOLVED SOLIDS; mg/L, Calculated | 49.68 | 423 | 463.8 | 510 | 714 |
| CONDUCTIVITY; uS/cm | 92 | 705 | 773 | 850 | 1020 |
| pH | 6.6 | 8.28 | 8.43 | 7.95 | 8.5 |
| TOTAL HARDNESS (CaCO₃) | 44 | 260 | 260 | 322 | 325 |
| CALCIUM HARDNESS (CaCO₃) | 26 | 160 | 158 | 182 | 195 |
| MAGNESIUM HARDNESS (CaCO₃) | 18 | 100 | 102 | 140 | 130 |
| P ALKALINITY (CaCO₃) | 0 | 0 | 0 | 0 | 10 |
| M ALKALINITY (CaCO₃) | 24 | 72 | 164 | 120 | 170 |
| OH ALKALINITY (CaCO₃) | | | | | |
| CHLORIDE (Cl) | 16 | | | | |
| SULFATE (SO₄⁻) | | | | | |
| SILICA (SiO₂) | | | | | |
| TOTAL PHOSPHATE (PO₄) | | | | | |
| acidified & boiled 30 minutes. | 0.01 | 0 | 9.7 | 0.02 | 7.8 |
| ORTHO PHOSPHATE; FILTERED (PO₄) | | 0 | 9.6 | 0.02 | 6.4 |
| ORTHO PHOSPHATE; UNFILTERED (PO₄) | | | | | |
| ORGANO-PHOSPHATE (PO₄) | | | | | |
| POLYPHOSPHATE (PO₄) | | | | | |
| NITRATE (NO₃) | | | | | |
| OIL & GREASE (FOG) | | | | | |
| TOTAL IRON (Fe) | | 0.07 | 0.08 | 0.35 | 0.3 |
| TOTAL COPPER (Cu) | | | | 0.25 | 0.38 |
| TOTAL MANGANESE (Mn) | | | | | |
| ZINC (Zn) | | | | | |
| TOTAL SUSPENDED SOLIDS | | | | | |
| SCALING INDEX [@140 F.] | 10.25 | 7.15 | 5.93 | 6.28 | 5.71 |

Overall, the results show that AS-8111 compares favorably with orthophosphate as a corrosion inhibitor for carbon steel under the conditions of the water quality and treatment dosages employed in this study.

The lack of pitting and localized corrosion by AS-8111 on carbon steel suggests that this inhibitor could be a treatment with substantial benefits over other relevant art. It was used at very low levels compared to phosphate and other commonly used cooling water treatments. This is an advantage in product handling and use.

The facts and data developed in this series of tests suggest that if longer tests were performed that even lower corrosion rates would have likely occurred with AS-8111. Notably, the AS-8111 system had lower equilibrium conversion rates than the PO₄ system.

The phosphate test program did not reach as low levels of corrosion on the Linear Polarization instrument as did the AS-8111 system and exhibited very severe pitting and localized attack.

Deposits were very extensive with the phosphate treatment since no scale inhibitor or deposit inhibitors were included with the basic treatments. The AS-8111 showed very little deposits which is another major advantage of this treatment. The lack of formation of calcium phosphate or iron phosphate in the AS-8111 system contributes to the useful benefits of the system. The absence of such deposits extends the efficiency of heat exchangers over time at high temperatures.

### EXAMPLES

Materials and Methods

An eight-port “corrosion rack” was added at the effluent end of each Advantage monitor. Both systems were cleaned of any residue, scale or corrosion products from a previous use. Then, in case there were any materials in the systems that would absorb any of the treatment chemicals, a solution of 25 mg/L of neat (as drummed) AS-8111 in deionized (DI) water at pH 9.0 was circulated over-night in the AS-8111 system. The same procedure was performed on the phosphate system with 10 mg/L PO₄ as PO₄. Both systems were thoroughly rinsed with DI water until all traces of the treatment chemicals were gone. These cleaning and “passivation” steps were done without the test specimens installed in the test rack.

A conventional “mild steel” (MS) corrosion coupon (alloy C1010) was installed in the top first position of each of the two eight-port corrosion racks in the circulating systems, plus one set of 3 MS “electrodes” or “tips” in Linear Polarization Probes (LPP) in each of the bottom first positions.

Two additional MS specimens have perforations with a series of holes to induce scale formation, one in each of the two Advantage scale and corrosion monitors. Each “scale” coupon also serves as a corrosion coupon.

The coupons were to remain in the systems until the end of the test at which time they were to be removed, photographed and processed for weight loss and mil per year (MPY) calculations, the same term as obtained from the LP instrument.

Both systems contained 10 gallons (37.85 Liters) of Evergreen city water supplemented with:
Calcium as calcium chloride dihydrate, CaCl₂•2H₂O,
Bicarbonate as sodium bicarbonate, NaHCO3,
Magnesium as magnesium sulfate septahydrate, MgSO₄•7H₂O, and
Silica as sodium silicate nonahydrate, Na₂SiO₃•9H₂O.

The water was supplemented to six times its normal content, as if the water had been concentrated by evaporation in a cooling tower, (except for the chloride, sodium and sulfate anions, which will be higher due to the salts used). The test water tended to be slightly scale-forming. However, as with most waters, it also will have a tendency to be corrosive, particularly if scale or precipitation occurs, taking some of the calcium, alkalinity and phosphate out of solution.

One system was treated with 5 mL of 50% AS-8111 equivalent to 1.8 mg/L Sn as Sn, the other with 10 mg/L orthophosphate as PO₄ from disodium phosphate, a slightly alkaline salt. The pH was adjusted, as necessary, to between 8.0 and 8.5, which is near optimum for corrosion inhibition of carbon steel, copper and copper alloys.

Summarizing the components of the test systems

The circulating systems each consisted of
A treated test water sump with pump and electrical heating elements capable of heating the test water to 140° F., with connecting hoses to and from the test units, containing a ball stop-valve.
An Advantage Model ADPM-1-A Scale Monitor consisting of: a gpm flow meter, inlet and outlet thermocouples with digital displays, a jacketed stainless steel tube containing heater and thermocouple for reading skin and water temperatures, with digital display, and perforated carbon steel coupon to induce scale formation at the 140° F. system temperature.
An eight port 1 inch PVC corrosion rack containing four corrosion coupons and four LP corrosion probes, each with 3-electrode tips for linear polarization instantaneous corrosion readings.

Other Instrumentation included:
Two (2) percent-timers to control the temperature of the two sumps at 140° F.
A Metal Samples Model MS 1500L LPR Data Logger for collecting and storing corrosion readings from the probes. The recorder can be downloaded in Excel format to a computer and graphed.
A Myron L Model 6P combination pH, ORP temperature and conductivity meter.
A Hach Model 2010 Spectrophotometer.
An Oven, desiccator and a 4-place balance for processing corrosion coupons.
Chemicals, reagents and equipment for processing corrosion coupons and for analyzing test water.

It is claimed:

1. A method for inhibiting corrosion of corrodible metal in contact with water in a cooling water system, comprising
(a) adding to said water system, a composition comprising a stannous salt of a non-carbon acid, or an aqueous solution thereof,
and (b) maintaining in said water system a concentration of said stannous salt which corresponds to a concentration of tin (Sn⁺²) between about 0.5 and about 10 ppm,
wherein said cooling water attains a temperature of between 80° F. and 160° F., during standard operating conditions.

2. The method of claim 1, wherein the stannous salt is selected from the group consisting of stannous bromide, chloride, sulfate, nitrate, and oxide.

3. The method of claim 2, wherein the stannous salt is stannous chloride.

4. The method of claim 1, wherein the concentration of stannous salt is maintained in the water system at a concentration which corresponds to a concentration of tin between about 1 and about 5 ppm.

5. The method of claim 1, wherein in step (i) the stannous salt is added in the form of an aqueous solution.

6. The method of claim 1, wherein said cooling water attains temperatures of at least 140° F. during standard operating conditions.

7. The method of claim 1, wherein the pH of said cooling water is 8 or higher.

8. The method of claim 1, wherein the calcium ion concentration of said cooling water is 150 ppm or higher.

9. The method of claim 8, wherein the calcium ion concentration of said cooling water is 200 ppm or higher.

10. The method of claim 1, wherein the corrodible metal is selected from a ferrous metal, copper, brass, and lead.

11. The method of claim 10, wherein the corrodible metal is a ferrous metal.

12. The method of claim 11, wherein the corrodible metal is carbon steel.
